(19) United States
(12) Patent Application Publication
(10) Pub. No.: US 2026/0275929 A1
(43) Pub. Date: Sep. 17, 2026

(54) METHODS AND SYSTEMS FOR CONTROLLING AN ENGINE FOLLOWING A FUEL CUT-OFF EVENT

(71) Applicant: Ford Global Technologies, LLC, Dearborn, MI (US)

(72) Inventors: Marcus Fried, Farmington Hills, MI (US); Marc G. Uphues, Ann Arbor, MI (US); Zena Yanqing Yee, Beverly Hills, MI (US); Stephen W. Magner, Farmington Hills, MI (US); Kenneth John Behr, Farmington Hills, MI (US); Jonathan Garza Bennet, Cuautitlán Izcalli (MX); Paul Mahlon Ranspach, Allen Park, MI (US)

(21) Appl. No.: 19/078,038

(22) Filed: Mar. 12, 2025

(51) Int. Cl. F02D 41/14; F02D 41/06

(52) U.S. Cl. CPC F02D 41/1454; F02D 41/065; F02D 41/1445; F02D 41/1494

(57) ABSTRACT

A system and a method are described for operating an engine following a fuel cut-off event. In one example, a method includes adjusting a fueling set point following a fuel cut-off event in response to feedback of a most downstream exhaust gas sensor of a plurality of exhaust gas sensors.

### TECHNICAL FIELD

The field of this application relates to adjusting a fueling set point following a fuel cut-off event.

### BACKGROUND AND SUMMARY

Gasoline engines are equipped with aftertreatment devices to treat combustion byproducts. In an effort to combat climate change, vehicles may be equipped with features to reduce engine runtimes. By doing this, an overall mass of combustion byproducts produced by the engine may be reduce over a total vehicle operating time.

When the engine is stopped, it may no longer receive fuel, referred to as a fuel cut-off event, which may result in one or more of the catalysts oxidizing and/or cooling, thereby reducing a catalytic activity of the aftertreatment device. Previous emissions systems may default to operate an engine rich following the fuel cut-off event. However, due to the variability of the fuel cut-off events that may occur during a vehicle operating period, a more robust method may be desired to enhance aftertreatment device operation and reduce emissions.

In one example, the issues described above may be at least partially solved by a method including adjusting a fueling set point following a fuel cut-off event in response to feedback of a most downstream exhaust gas sensor of a plurality of exhaust gas sensors. In this way, multiple aftertreatment devices may be maintained following the fuel cut-off event.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The above advantages and other advantages, and features of the present description will be readily apparent from the following Detailed Description when taken alone or in connection with the accompanying drawings.

FIG. 1 shows an example cylinder of an internal combustion engine in accordance with the present disclosure.

FIG. 2 shows an example of an exhaust system with a plurality of aftertreatment devices and sensors.

FIG. 3 shows a high-level flow chart for controlling a fuel set point following a fuel cut-off event.

FIG. 4 shows a method for executing an adjusted fueling set point following a cut-off event.

FIG. 5 graphically illustrates an operating sequence surrounding a fuel cut-off event.

### DETAILED DESCRIPTION

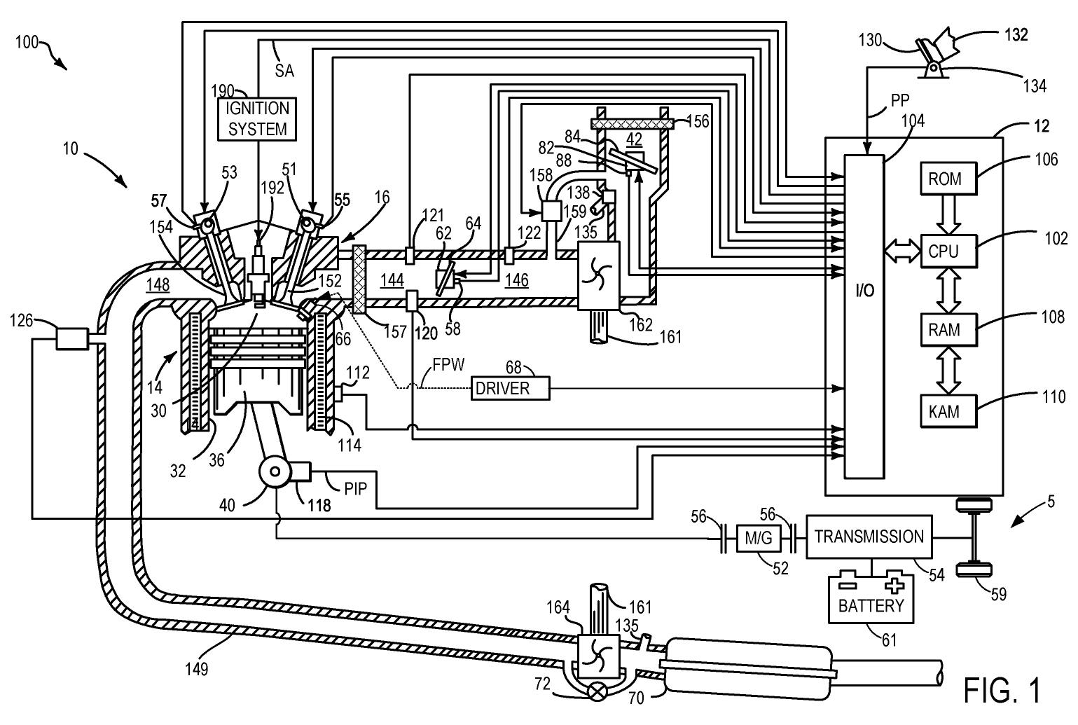

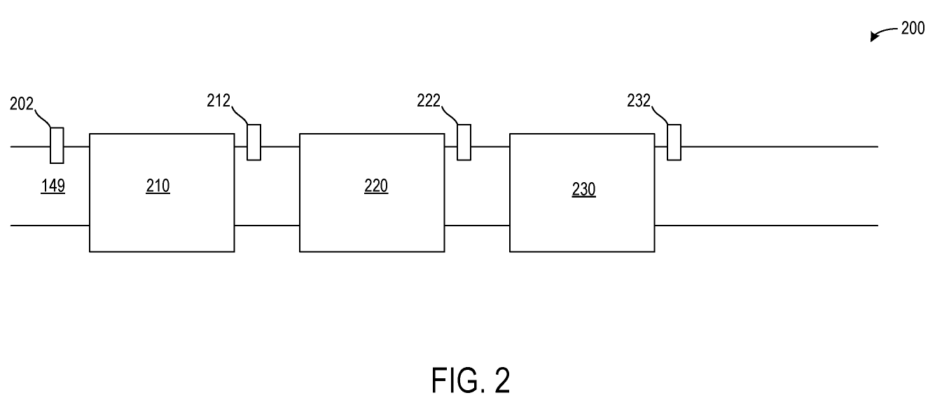

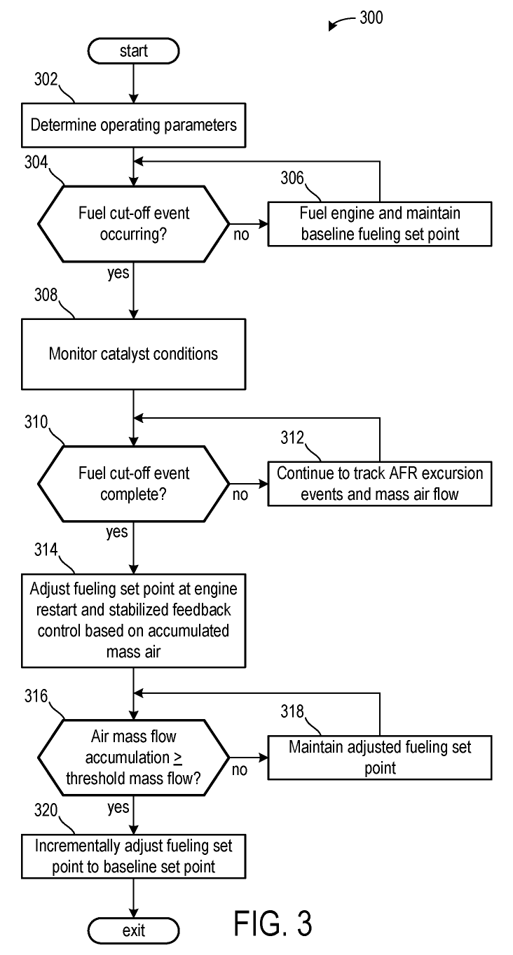

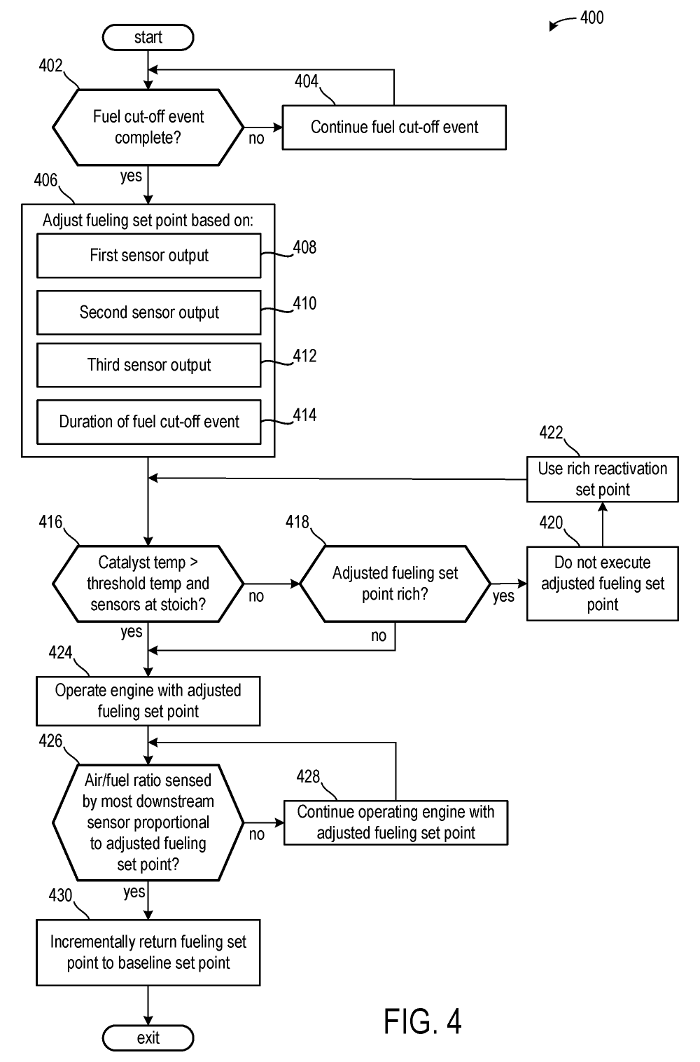

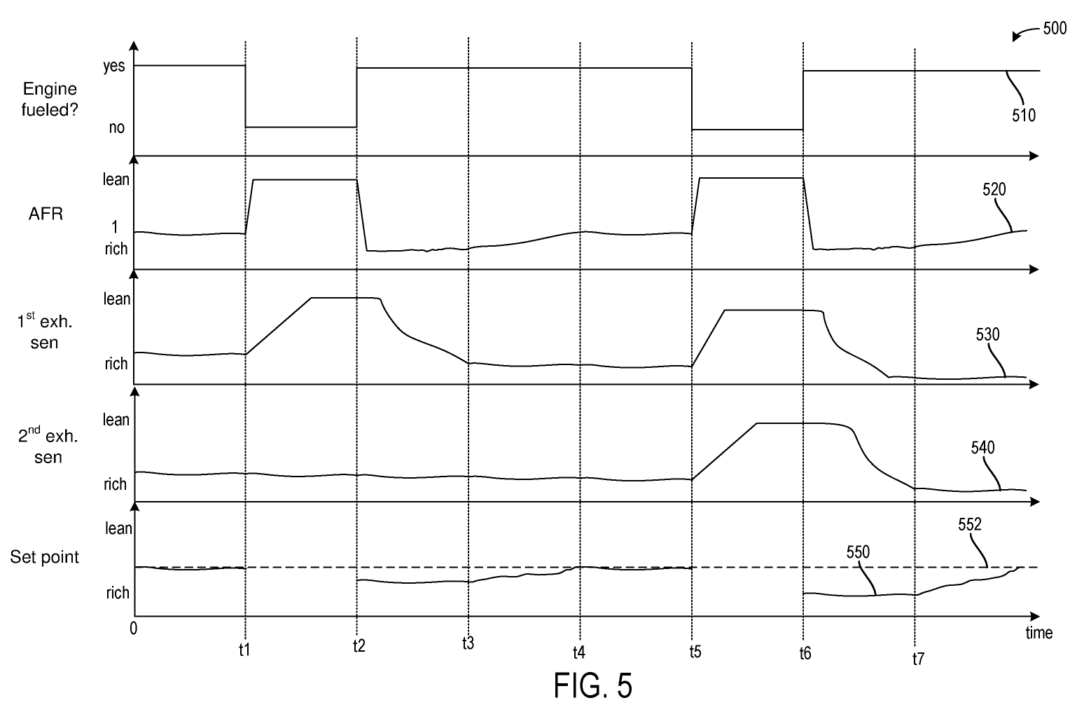

The following description describes methods and system for an exhaust system of an engine. FIG. 1 shows an example cylinder of an internal combustion engine in accordance with the present disclosure. FIG. 2 shows an example of an exhaust system with a plurality of aftertreatment devices and sensors. FIG. 3 shows a high-level flow chart for controlling a fuel set point following a fuel cut-off event. FIG. 4 shows a method for executing an adjusted fueling set point following a cut-off event. FIG. 5 graphically illustrates an operating sequence surrounding a fuel cut-off event.

FIG. 1 depicts an engine system 100 for a vehicle. The vehicle may be an on-road vehicle having drive wheels which contact a road surface. Engine system 100 includes engine 10 which comprises a plurality of cylinders. FIG. 1 describes one such cylinder or combustion chamber in detail. The various components of engine 10 may be controlled by electronic engine controller 12.

Engine 10 includes a cylinder block 14 including at least one cylinder bore 30, and a cylinder head 16 including intake valves 152 and exhaust valves 154. In other examples, the cylinder head 16 may include one or more intake ports and/or exhaust ports in examples where the engine 10 is configured as a two-stroke engine. The cylinder block 14 includes cylinder walls 32 with piston 36 positioned therein and connected to crankshaft 40. Thus, when coupled together, the cylinder head 16 and cylinder block 14 may form one or more combustion chambers. As such, the combustion chamber 30 volume is adjusted based on an oscillation of the piston 36. Combustion chamber 30 may also be referred to herein as cylinder 30. The combustion chamber 30 is shown communicating with intake manifold 144 and exhaust manifold 148 via respective intake valves 152 and exhaust valves 154. Each intake and exhaust valve may be operated by an intake cam 51 and an exhaust cam 53. Alternatively, one or more of the intake and exhaust valves may be operated by an electromechanically controlled valve coil and armature assembly. The position of intake cam 51 may be determined by intake cam sensor 55. The position of exhaust cam 53 may be determined by exhaust cam sensor 57. Thus, when the valves 152 and 154 are closed, the combustion chamber 30 and cylinder bore may be fluidly sealed, such that gases may not enter or leave the combustion chamber 30.

Combustion chamber 30 may be formed by the cylinder walls 32 of cylinder block 14, piston 36, and cylinder head 16. Cylinder block 14 may include the cylinder walls 32, piston 36, crankshaft 40, etc. Cylinder head 16 may include one or more fuel injectors such as fuel injector 66, one or more intake valves 152, and one or more exhaust valves such as exhaust valves 154. The cylinder head 16 may be coupled to the cylinder block 14 via fasteners, such as bolts and/or screws. In particular, when coupled, the cylinder block 14 and cylinder head 16 may be in sealing contact with one another via a gasket, and as such the cylinder block 14 and cylinder head 16 may seal the combustion chamber 30, such that gases may only flow into and/or out of the combustion chamber 30 via intake manifold 144 when intake valves 152 are opened, and/or via exhaust manifold 148 when exhaust valves 154 are opened. In some examples, only one intake valve and one exhaust valve may be included for each combustion chamber 30. However, in other examples, more than one intake valve and/or more than one exhaust valve may be included in each combustion chamber 30 of engine 10.

In some examples, each cylinder of engine 10 may include a spark plug 192 for initiating combustion. Ignition system 190 can provide an ignition spark to cylinder 14 via spark plug 192 in response to spark advance signal SA from controller 12, under select operating modes. However, in some embodiments, spark plug 192 may be omitted, such as where engine 10 may initiate combustion by auto-ignition or by injection of fuel as may be the case with some diesel engines.

Fuel injector 66 may be positioned to inject fuel directly into combustion chamber 30, which is known to those skilled in the art as direct injection. Fuel injector 66 delivers liquid fuel in proportion to the pulse width of signal FPW from controller 12. Fuel is delivered to fuel injector 66 by a fuel system (not shown) including a fuel tank, fuel pump, and fuel rail. Fuel injector 66 is supplied operating current from driver 68 which responds to controller 12. In some examples, the engine 10 may be a gasoline engine, and the fuel tank may include gasoline, which may be injected by injector 66 into the combustion chamber 30. However, in other examples, the engine 10 may be a diesel engine, and the fuel tank may include diesel fuel, which may be injected by injector 66 into the combustion chamber. Further, in such examples where the engine 10 is configured as a diesel engine, the engine 10 may include a glow plug to initiate combustion in the combustion chamber 30.

The engine may be operated based on a stoichiometric air/fuel ratio. Air/fuel ratios lower than stoichiometric may be considered rich and include a greater amount of fuel to air relative to a stoichiometric mixture. Conversely, air/fuel ratios higher than stoichiometric may be considered lean and include a greater amount of air to fuel relative to the stoichiometric mixture. As such, a more rich air/fuel mixture may refer to maintaining a previous volume of air introduced to a cylinder while increasing an amount of fuel. A more lean air/fuel mixture may refer to maintain a previous amount of fuel introduced to the cylinder while increasing an amount of air.

Intake manifold 144 is shown communicating with throttle 62 which adjusts a position of throttle plate 64 to control airflow to engine cylinder 30. This may include controlling airflow of boosted air from intake boost chamber 146. In some embodiments, throttle 62 may be omitted and airflow to the engine may be controlled via a single air intake system throttle (AIS throttle) 82 coupled to air intake passage 42 and located upstream of the intake boost chamber 146. In yet further examples, AIS throttle 82 may be omitted and airflow to the engine may be controlled with the throttle 62.

In some embodiments, engine 10 is configured to provide exhaust gas recirculation, or EGR. When included, EGR may be provided as high-pressure EGR and/or low-pressure EGR. In examples where the engine 10 includes low-pressure EGR, the low-pressure EGR may be provided via EGR passage 135 and EGR valve 138 to the engine air intake system at a position downstream of air intake system (AIS) throttle 82 and upstream of compressor 162 from a location in the exhaust system downstream of turbine 164. EGR may be drawn from the exhaust system to the intake air system when there is a pressure differential to drive the flow. A pressure differential can be created by partially closing AIS throttle 82. Throttle plate 84 controls pressure at the inlet to compressor 162. The AIS may be electrically controlled and its position may be adjusted based on optional position sensor 88.

Ambient air is drawn into combustion chamber 30 via intake passage 42, which includes air filter 156. Thus, air first enters the intake passage 42 through air filter 156. Compressor 162 then draws air from air intake passage 42 to supply boost chamber 146 with compressed air via a compressor outlet tube (not shown in FIG. 1). In some examples, air intake passage 42 may include an air box (not shown) with a filter. In one example, compressor 162 may be a turbocharger, where power to the compressor 162 is drawn from the flow of exhaust gases through turbine 164. Specifically, exhaust gases may spin turbine 164 which is coupled to compressor 162 via shaft 161. A wastegate 72 allows exhaust gases to bypass turbine 164 so that boost pressure can be controlled under varying operating conditions. Wastegate 72 may be closed (or an opening of the wastegate may be decreased) in response to increased boost demand, such as during an operator pedal tip-in. By closing the wastegate, exhaust pressures upstream of the turbine can be increased, raising turbine speed and peak power output. This allows boost pressure to be raised. Additionally, the wastegate can be moved toward the closed position to maintain desired boost pressure when the compressor recirculation valve is partially open. In another example, wastegate 72 may be opened (or an opening of the wastegate may be increased) in response to decreased boost demand, such as during an operator pedal tip-out. By opening the wastegate, exhaust pressure can be reduced, reducing turbine speed and turbine power. This allows boost pressure to be lowered.

However, in alternate embodiments, the compressor 162 may be a supercharger, where power to the compressor 162 is drawn from the crankshaft 40. Thus, the compressor 162 may be coupled to the crankshaft 40 via a mechanical linkage such as a chain. As such, a portion of the rotational energy output by the crankshaft 40, may be transferred to the compressor 162 for powering the compressor 162.

Compressor recirculation valve 158 (CRV) may be provided in a compressor recirculation path 159 around compressor 162 so that air may move from the compressor outlet to the compressor inlet so as to reduce a pressure that may develop across compressor 162. A charge air cooler 157 may be positioned in boost chamber 146, downstream of compressor 162, for cooling the boosted aircharge delivered to the engine intake. However, in other examples as shown in FIG. 1, the charge air cooler 157 may be positioned downstream of the electronic throttle 62 in an intake manifold 144. In some examples, the charge air cooler 157 may be an air to air charge air cooler. However, in other examples, the charge air cooler 157 may be a liquid to air cooler.

In the depicted example, compressor recirculation path 159 is configured to recirculate cooled compressed air from upstream of charge air cooler 157 to the compressor inlet. In alternate examples, compressor recirculation path 159 may be configured to recirculate compressed air from downstream of the compressor and downstream of charge air cooler 157 to the compressor inlet. CRV 158 may be opened and closed via an electric signal from controller 12. CRV 158 may be configured as a three-state valve having a default semi-open position from which it can be moved to a fully-open position or a fully-closed position.

Universal Exhaust Gas Oxygen (UEGO) sensor 126 is shown coupled to exhaust manifold 148 upstream of emission control device 70. Alternatively, a two-state exhaust gas oxygen sensor may be substituted for UEGO sensor 126. Emission control device 70 may include multiple catalyst bricks, in one example. In another example, multiple emission control devices, each with multiple bricks, can be used. While the depicted example shows UEGO sensor 126 upstream of turbine 164, it will be appreciated that in alternate embodiments, UEGO sensor may be positioned in the exhaust manifold downstream of turbine 164 and upstream of emission control device 70. Additionally or alternatively, the emission control device 70 may comprise a diesel oxidation catalyst (DOC) and/or a diesel cold-start catalyst, a particulate filter, a three-way catalyst, a NO x trap, selective catalytic reduction device, and combinations thereof. In some examples, a sensor may be arranged upstream or downstream of the emission control device 70, wherein the sensor may be configured to diagnose a condition of the emission control device 70. In some examples, emission control device 70 may be a close-coupled emission control device, wherein the emission control device 70 is close-coupled relative to the engine 10. In one example, close-coupling of the emission control device 70 to the engine 10 may include where the turbine 164 is integrally formed with the cylinder head 16 as a single-piece, and where an outlet of the turbine 164 opens directly into the emission control device 70 with no components intervening therebetween.

Controller 12 is shown in FIG. 1 as a microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an input device 130 for sensing input device pedal position (PP) adjusted by a vehicle operator 132; a knock sensor for determining ignition of end gases (not shown); a measurement of engine manifold pressure (MAP) from pressure sensor 121 coupled to intake manifold 144; a measurement of boost pressure from pressure sensor 122 coupled to boost chamber 146; an engine position sensor from a Hall effect sensor 118 sensing crankshaft 40 position; a measurement of air mass entering the engine from sensor 120 (e.g., a hot wire air flow meter); and a measurement of throttle position from sensor 58. Barometric pressure may also be sensed (sensor not shown) for processing by controller 12. In a preferred aspect of the present description, Hall effect sensor 118 produces a predetermined number of equally spaced pulses every revolution of the crankshaft from which engine speed (RPM) can be determined. The input device 130 may comprise a foot driving and a foot caliper pedal. As such, output from the position sensor 134 may be used to determine the position of the pedal(s) of the input device 130, and therefore determine a desired engine torque. Thus, a desired engine torque as requested by the vehicle operator 132 may be estimated based on the pedal position of the input device 130.

In some examples, vehicle 5 may be a hybrid vehicle with multiple sources of torque available to one or more vehicle wheels 59. In other examples, vehicle 5 is a conventional vehicle with only an engine, or an electric vehicle with only electric machine(s). In the example shown, vehicle 5 includes engine 10 and an electric machine 52. Electric machine 52 may be a motor or a motor/generator. Crankshaft 40 of engine 10 and electric machine 52 are connected via a transmission 54 to vehicle wheels 59 when one or more clutches 56 are engaged. In the depicted example, a first clutch 56 is provided between crankshaft 40 and electric machine 52, and a second clutch 56 is provided between electric machine 52 and transmission 54. Controller 12 may send a signal to an actuator of each clutch 56 to engage or disengage the clutch, so as to connect or disconnect crankshaft 40 from electric machine 52 and the components connected thereto, and/or connect or disconnect electric machine 52 from transmission 54 and the components connected thereto. Transmission 54 may be a gearbox, a planetary gear system, or another type of transmission. The powertrain may be configured in various manners including as a parallel, a series, or a series-parallel hybrid vehicle.

Electric machine 52 receives electrical power from a traction battery 61 to provide torque to vehicle wheels 59. Electric machine 52 may also be operated as a generator to provide electrical power to charge battery 61, for example during a caliper operation.

The controller 12 receives signals from the various sensors of FIG. 1 and employs the various actuators of FIG. 1 to adjust engine operation based on the received signals and instructions stored on a memory of the controller. For example, adjusting operation of the electric machine 52 may occur based on feedback from ECT sensor 112. As another example, the controller may receive feedback regarding one or more combustion conditions and actuate one or more valves of a fluid injection arrangement in response to the one or more conditions. The valves and fluid injection arrangement are described in greater detail herein.

Turning now to FIG. 2, it shows an aftertreatment system 200 including the exhaust passage 149 of FIG. 1. As such, components previously introduced may be similarly numbered in this and subsequent figures. The exhaust passage 149 may include a plurality of aftertreatment devices. Each aftertreatment device of the plurality of aftertreatment devices may include a corresponding sensor arranged downstream thereof for closed-loop control, wherein a downstream arrangement is relative to a direction of exhaust gas flow.

The plurality of aftertreatment devices includes a first aftertreatment device 210 and a first sensor 212. The first sensor 212 is arranged directly downstream of the first aftertreatment device 210 such that exhaust gas flow through the first aftertreatment device 210 prior to flowing to the first sensor 212. The first aftertreatment device 210 may be arranged downstream of a primary exhaust gas sensor 202. The primary exhaust gas sensor 202 may be used for inner closed loop control whereas the first sensor 212 may be used for outer closed loop control. The primary exhaust gas sensor 202 may be similar to the UEGO sensor 126 of FIG. 1.

The plurality of aftertreatment devices may further include a second aftertreatment device 220 and a second sensor 222, both downstream of the first sensor 212. The second sensor 222 is arranged directly downstream of the second aftertreatment device 220.

The plurality of aftertreatment devices may further include a third aftertreatment device 230 and a third sensor 232, both downstream of the second sensor 222. The third sensor 232 is arranged directly downstream of the third aftertreatment device 230.

In one example, each of the first sensor 212, the second sensor 222, and the third sensor 232 may be exhaust sensors, such as a heat exhaust gas oxygen (HEGO) sensor. Additionally or alternatively, one or more of the first sensor 212, the second sensor 222, and the third sensor 232 may be a universal exhaust gas oxygen (UEGO) sensor or other type of catalyst monitor sensor. In one example, the primary exhaust gas sensor 202 is a UEGO sensor.

Due to the locations of the sensors, the sensors may be referred to herein as an upstream sensor or a downstream sensor with respect to the aftertreatment device (e.g., catalyst) being discussed. For example, with respect to the second aftertreatment device 220, the first sensor 212 is an upstream sensor and the second sensor 222 is a downstream sensor. The first sensor 212 may provide inner loop feedback control and the second sensor 222 may provide outer loop feedback control of the second aftertreatment device 220.

The plurality of aftertreatment devices may be identical to one another in size, shape, and catalyst make-up. Additionally or alternatively, the plurality of aftertreatment devices may be different from one another. The plurality of aftertreatment devices may include one or more of a particulate filter, a NOₓ trap, a three-way catalyst (TWC), or other type of aftertreatment device.

Turning now to FIG. 3, it shows a method 300 for adjusting a fueling set point in response to a fuel cut-off event. Instructions for carrying out method 300 and the rest of the methods included herein may be executed by a controller based on instructions stored on a memory of the controller and in conjunction with signals received from sensors of the engine system, such as the sensors described above with reference to FIG. 1. The controller may employ engine actuators of the engine system to adjust engine operation, according to the methods described below.

The method 300 begins at 302, which includes determining operating parameters. Operating parameters may include but are not limited to an air mass, an engine load, an engine speed, an engine temperature, a throttle position, and an air/fuel ratio.

At 304, the method 300 may include determining if a fuel cut-off event is occurring. The fuel cut-off event may correspond to one or more of a decreasing vehicle speed, a stop, and an all-electric operation. The fuel cut-off may include ceasing fuel flow to the engine. As such, fuel injectors of the engine may be deactivated and combustion in the engine may no longer occur.

If the fuel cut-off event is not occurring, then at 306, the method 300 may include fueling the engine and maintaining a baseline fueling set point. The baseline fueling set point may be a set point based on uninterrupted engine operation, which may include wherein the engine is on and decreasing of vehicle speed is not occurring.

If the fuel cut-off event is occurring, then at 308, the method 300 may include monitoring catalyst conditions. Monitoring catalyst conditions may include one or more of estimate a mass flow accumulation, estimating an oxidized state of the catalyst, and sensing an air-fuel ratio downstream of the catalyst. Estimating the mass flow accumulation may include measuring an air/fuel ratio through the exhaust passage. In one example, the air/fuel ratio detected by the primary exhaust gas sensor may be compared to the air/fuel ratio detected by a sensor downstream of an aftertreatment device, such as the first sensor 212, the second sensor 222, and/or the third sensor 232 of FIG. 2. By comparing the air fuel ratio detected by both sensors, then an air/fuel ratio check is passed and the fuel cut-off event is affecting an oxidative state of at least one aftertreatment device. For example, if the first sensor and the second sensor measure lean similar to the primary exhaust gas sensor, but the third sensor reads rich, then the fuel cut-off event may be oxidizing only the first aftertreatment device and the second aftertreatment device. If the AFR sensors have detected both a low voltage (lean) and a high voltage (rich) excursion, then the catalyst section has cycled, and a mass air flow term is accumulated over time and reset when the fuel cut-off starts over again from uninterrupted operation to a fuel cut-off event.

At 310, the method 300 may include determining if the fuel cut-off event is complete. The fuel cut-off event may be complete if an increase in vehicle speed is occurring and/or if the engine is restarted.

If the fuel cut-off event is not complete, then at 312, the method 300 may include continuing to track air/fuel ratio excursion events and mass air flow.

If the fuel cut-off event is complete, then at 314, the method 300 may include adjusting a fueling set point at engine restart and stabilized feedback control (e.g., the downstream sensor detects the catalyst is recovered) based on the accumulated air mass. Stabilized feedback control may include cycling through several stages of reactivation including open loop fueling, inner loop feedback fuel when an upstream exhaust sensor is active, and outer loop fuel feedback when a downstream exhaust sensor is active. The catalyst is recovered once the catalyst returns to a catalytic state suitable for treating emissions. For example, the fueling set point at the engine restart may be rich based on a magnitude of the lean air flow and a duration of the lean air flow. At the restart, the engine fueling is adjusted based on the adjusted fueling set point. In this way, the engine fueling may be adjusted to a prescribed amount to regenerate the catalyst(s) back to a more catalytically active state.

In one example, the fueling set point may be adjusted for only aftertreatment devices with corresponding exhaust sensors sensing an air/fuel ratio similar to the primary exhaust gas sensor. For example, if only the first sensor senses an air/fuel ratio similar to the primary exhaust gas sensor and the second sensor and third sensor sense an air/fuel ratio different than the primary exhaust gas sensor, then the adjusted fueling set point may be based on a state of only the first aftertreatment device. Alternatively, if the first and second sensors sense an air/fuel ratio similar to the primary exhaust sensor and the third sensor senses an air/fuel ratio different than the primary exhaust gas sensor, then the adjusted fueling set point may be based on a state of the first and second aftertreatment devices. Furthermore, if each of the first, second, and third sensors sense an air/fuel ratio similar to the primary exhaust gas sensor, then the adjusted fueling set point may be based on a state of each of the first, second, and third aftertreatment devices.

In one example, the adjustment may be a fixed amount for each aftertreatment device or a dynamic amount. For example, the dynamic adjustment may decrease as the number of aftertreatment devices for which the fueling set point is adjusted increases. That is to say, a proportional adjustment (e.g., adjustment per aftertreatment device) of the fueling set point based on only the first aftertreatment device may be greater than a proportional adjustment of the fueling set point based on the first and second aftertreatment devices and/or the first, second, and third aftertreatment devices. However, a total fueling set point adjustment increases as the number of aftertreatment devices for which the fueling set point is adjusted increases. In one example, the fueling set point is adjusted by a first value in response to only the first aftertreatment device. The fueling set point may be adjusted by a second value in response to the first and second aftertreatment devices, wherein the second value may be between 100-200% of the first value. The fueling set point may be adjusted by a third value in response to the first, second, and third aftertreatment devices, wherein the third value may be between 200-300% of the first value.

At 316, the method 300 may include determining if the air mass flow accumulation is greater than or equal to a threshold mass flow accumulation. The threshold mass flow accumulation is based on an estimated mass flow at the adjusted fueling set point configured to regenerate the aftertreatment device(s).

If the air mass flow accumulation is not greater than or equal to the threshold mass accumulation, then at 318, the method 300 may include maintaining the adjusted fueling set point. As such, the engine may be fueled at a set point different than the baseline fueling set point.

If the air mass flow accumulation is greater than or equal to the threshold mass flow accumulation, then at 320, the method 300 may include incrementally adjusting the fueling set point toward the baseline set point. For example, if the adjusted fueling set point is richer than the baseline set point, then the adjusted fueling set point may be incrementally leaned toward the baseline set point. Alternatively, if the adjusted fueling set point is leaner than the baseline set point, then the adjusted fueling set point may be incrementally richened toward the baseline set point.

Turning now to FIG. 4, it shows a method 400 for operating the adjusted fueling set point following a fuel cut-off event. At 402, the method 400 includes determining if a fuel cut-off event is complete. The fuel cut-off event may be complete if an increase in vehicle speed is occurring and/or if the engine is restarted. If the fuel cut-off event is not complete, then at 404, the method 400 may include continuing the fuel cut-off event.

If the fuel cut-off event is complete, then at 406, the method 400 may include adjusting a fueling set point based on a first sensor output at 408, a second sensor output at 410, a third sensor output at 412, and a duration of the fuel cut-off event 414. The fueling set point may be further adjusted in response to a driver demand upon restarting the engine. In this way, the adjusted fueling set point may be set to regenerate one or more of the aftertreatment devices and meet driver demand.

In one example, the first sensor output, the second sensor output, and the third sensor output are compared to an output of the primary exhaust gas sensor. If none of the first, second, and third sensor outputs transitioned to a lean output during the fuel cut-off event, then regeneration of the aftertreatment devices is not demanded and the adjusted fueling set point may be based on only a driver demand and/or may be set to the baseline fueling set point. If one or more of the first, second, and third sensor outputs transitioned to a lean output during the fuel cut-off event, then regeneration of the corresponding aftertreatment devices is demanded and the adjusted fueling set point may be based on at least the demanded regeneration.

At 416, the method 400 may include determining if a catalyst temperature is greater than a threshold temperature and the downstream air/fuel ratio sensors indicate stoichiometry. The threshold temperature may be based on a catalyst light off temperature. Additionally or alternatively, the threshold temperature may be based on a catalyst regeneration temperature. In some examples, if multiple aftertreatment devices demand regeneration, then a temperature of an upstream aftertreatment device may be determined. If the temperature of at least the upstream aftertreatment device is greater than the threshold temperature, then the upstream aftertreatment device may be in a desired condition for regeneration. The temperatures of the downstream aftertreatment devices may increase as the upstream catalyst is regenerated. Additionally, the downstream AFR sensors may indicate that the catalyst sections have reached near stoichiometry (nominal AFR ratio indicating no extra oxidants or reductants in exhaust gas) operation, so as to transition into closed loop operation associated with uninterrupted engine operation.

If the catalyst temperature is not greater than the threshold temperature (e.g., less than or equal to) or the AFR sensors indicate non-stoichiometry conditions, then at 418, the method 400 may include determining if the adjusted fueling set point is rich. If the adjusted fueling set point is rich, then at 420, the method 400 may include not executing the adjusted fueling set point at the engine restart.

At 422, the method 400 may include implementing the initial catalyst reactivation (before the AFR downstream sensors read rich) fueling set point at the engine restart and continuing to monitor the catalyst temperature. Once the catalyst temperature is greater than the threshold temperature and the downstream AFR sensors indicate the catalyst is no longer strongly oxidized, then the excess fuel may be treated and not released to the environment.

If the catalyst temperature is greater than the threshold temperature at 416 or if the adjusted fueling set point is not rich at 418, then at 424, the method 400 may include operating the engine with the adjusted fueling set point. As such, the engine may be operated with a fueling set point different than the baseline fueling set point. In this way, the engine may receive more fuel or less fuel relative to the baseline fueling set point at the engine restart.

At 426, the method 400 may include determining if an air/fuel ratio sensed by a most downstream exhaust sensor is proportional to an air/fuel ratio corresponding to the adjusted fueling set point. For example, if the most downstream exhaust sensor does not switch from a lean air/fuel ratio to a less lean air/fuel ratio, then the most downstream aftertreatment device has not transitioned from a state corresponding to the fuel cut-off event to a state corresponding to the adjusting fueling set point. If the most downstream exhaust sensor provides feedback that is not proportional to an air/fuel ratio corresponding to the adjusted fueling set point, then at 428, the method 400 may include continuing to operate the engine with the adjusted fueling set point.

If the most downstream exhaust sensor provides feedback that is proportional to an air/fuel ratio corresponding to the adjusted fueling set point, then the downstream aftertreatment device and all aftertreatment devices upstream thereof have transitioned from a fuel cut-off event state to a state corresponding to the adjusted fueling set point. In one example, each of the aftertreatment devices may be regenerated and therefore returned to a state more efficient for treating combustion byproducts. At 430, the method 400 may include incrementally returning the fueling set point to the baseline set point. Incrementally returning the fueling set point to the baseline set point may include linearly altering the fueling set point to the baseline set point or adjusting the fueling set-point stepwise to the baseline set point.

Turning now to FIG. 5, it shows a plot 500 illustrating changes to a fuel operating set point in response to an open loop air/fuel ratio, a first exhaust sensor output, and a second exhaust sensor output. Plot 510 illustrates if an engine is fueled. Plot 520 illustrates an air/fuel ratio sensed by a primary exhaust gas sensor. Plot 530 illustrates a first exhaust sensor output. Plot 540 illustrates a second exhaust sensor output. Plot 550 illustrates an engine fueling set point and dashed line 552 illustrates a baseline fueling set point. The engine is not fueled when plot 550 is not visible. Time increases from a left to a right side of the figure.

Prior to t1, the engine is fueled. The air/fuel ratio sensed by the primary exhaust gas sensor is substantially equal to stoichiometric. The first exhaust sensor and the second exhaust sensor sense air/fuel ratios similar to the primary exhaust gas sensor. As such, an initial state of the first aftertreatment device, corresponding to the first exhaust sensor, and of the second aftertreatment device, corresponding to the second exhaust sensor, is known. The fueling set point is equal to the baseline fueling set point.

At t1, the engine is no longer fueled. As such, a fuel cut-off event is initiated.

Between t1 and t2, the air/fuel ratio sensed by the primary exhaust gas sensor is equal to a fully lean air/fuel ratio. The air/fuel ratio sensed by the first exhaust sensor is also equal to the fully lean air/fuel ratio, thereby indicating an initial state of the first aftertreatment device. The air/fuel ratio sensed by the second exhaust sensor is substantially unchanged, and as such, the initial state of the second aftertreatment device during the fuel cut-off event is undetermined.

At t2, the fuel cut-off event is terminated.

Between t2 and t3, the engine is fueled. The air/fuel ratio sensed by the primary exhaust gas sensor is substantially equal to a rich air/fuel ratio proportional to an adjusted fueling set point. The adjusted fueling set point is set to a rich set point relative to the baseline fueling set point. The first exhaust sensor reading becomes more rich.

At t3, the first exhaust sensor reading corresponds to an air/fuel ratio proportional to the adjusted fueling set point. As such, a state of the first aftertreatment device is determined due to a similar reading between the primary exhaust gas sensor and the first exhaust sensor. In one example, a regeneration of the first aftertreatment device is complete.

Between t3 and t4, the fueling set point is gradually adjusted to return to the baseline set point. As illustrated, the fueling set point is linearly returned to the baseline fueling set point. In some examples, the fueling set point may be adjusted by a fixed percentage over time until it is equal to the baseline fueling set point.

At t4 and between t4 and t5, the engine is fueled an operated at the baseline fueling set point. States of the first and second aftertreatment devices are determined.

At t5, the engine is not fueled and a fuel cut-off event is initiated.

Between t5 and t6, the air/fuel ratios sensed by the primary exhaust gas sensor, the first exhaust sensor, and the second exhaust sensor are fully lean. As such, a state of the first and second aftertreatment devices is determined. In this way, a fueling set point during an engine restart upon exiting the fuel cut-off event may account for each of the first and second aftertreatment devices.

At t6, the engine is fueled based on the adjusted fueling set point.

Between t6 and t7, the air/fuel ratios sensed by the primary exhaust gas sensor, the first exhaust sensor, and the second exhaust sensor become less lean.

At t7, the second exhaust sensor reading corresponds to an air/fuel ratio proportional to the adjusted fueling set point. As such, a state of the first aftertreatment device and the second after treatment device is determined due to a similar reading between the primary exhaust gas sensor, the first exhaust sensor, and the second exhaust sensor. In one example, a regeneration of the first aftertreatment device and the second aftertreatment device is complete.

After t7, the fueling set point is returned gradually to the baseline set point.

The disclosure also provides support for a method, comprising: adjusting a fueling set point following a fuel cut-off event in response to feedback of a most downstream exhaust gas sensor of a plurality of exhaust gas sensors. In a first example of the method, each of the plurality of exhaust gas sensors is arranged downstream of an aftertreatment device. In a second example of the method, optionally including the first example, each of the plurality of exhaust gas sensors is a heated exhaust gas oxygen (HEGO) sensor. In a third example of the method, optionally including one or both of the first and second examples, the method further comprises: a universal exhaust gas oxygen (UEGO) sensor upstream of each of the plurality of exhaust gas sensors. In a fourth example of the method, optionally including one or more or each of the first through third examples, adjusting the fueling set point comprises adjusting the fueling set point to more rich or more lean based on a state of an aftertreatment device corresponding to the most downstream exhaust gas sensor. In a fifth example of the method, optionally including one or more or each of the first through fourth examples, the method further comprises: returning the fueling set point to a baseline fueling set point in response to the most downstream exhaust gas sensor matching an upstream sensor following the fuel cut-off event. In a sixth example of the method, optionally including one or more or each of the first through fifth examples, returning the fueling set point to the baseline fueling set point comprises incrementally adjusting the fueling set point to match the baseline fueling set point.

The disclosure also provides support for a system, comprising: an exhaust system comprising a primary exhaust gas sensor upstream of a plurality of aftertreatment devices, a plurality of exhaust gas sensors arranged in the exhaust system, and wherein at least one of the plurality of exhaust gas sensors is arranged downstream of at least one of the plurality of aftertreatment devices, and a controller comprising instructions stored on non-transitory memory thereof that when executed enable the controller to: initiate a fuel cut-off event, sense a state of each of the plurality of aftertreatment devices, and adjust a fueling set point following the fuel cut-off event in response to the state of at least one of the plurality of aftertreatment devices. In a first example of the system, the state of each of the plurality of aftertreatment devices is based on feedback of a sensor of the plurality of exhaust gas sensors directly downstream of a corresponding aftertreatment device. In a second example of the system, optionally including the first example, the state of each of the plurality of aftertreatment devices indicates if a fueling set point rich or lean of a baseline set point is requested. In a third example of the system, optionally including one or both of the first and second examples, the instructions further cause the controller to adjust the fueling set point based on a state of each of the plurality of aftertreatment devices. In a fourth example of the system, optionally including one or more or each of the first through third examples, the fueling set point is further adjusted based on a duration of the fuel cut-off event. In a fifth example of the system, optionally including one or more or each of the first through fourth examples, the fueling set point is incrementally returned to a baseline fueling set point in response to an output of a most downstream of the plurality of exhaust gas sensors matching an output of the primary exhaust gas sensor. In a sixth example of the system, optionally including one or more or each of the first through fifth examples, the fueling set point is adjusted at an engine restart following the fuel cut-off event. In a seventh example of the system, optionally including one or more or each of the first through sixth examples, the fueling set point is incrementally returned to a baseline fueling set point in response to a mass air flow accumulation being greater than or equal to a threshold mass flow accumulation.

The disclosure also provides support for a method comprising: operating an engine after a fuel cut-off event, monitoring a air fuel ratio sensed by an exhaust sensor positioned downstream of an aftertreatment device, adjusting a fueling set point of the engine incrementally toward a baseline fueling set point based on the mass flow accumulation. In a first example of the method, the method further includes monitoring the mass flow accumulation prior to the fuel cut off event and comparing a response of the exhaust oxygen sensor to a primary exhaust gas sensor arranged upstream of the aftertreatment device. In a second example of the method, optionally including the first example, the method further includes comparing feedback from a primary exhaust gas sensor arranged upstream of the aftertreatment device to feedback from a plurality of exhaust sensors including the exhaust sensor. In a third example of the method, optionally including one or both of the first and second examples, the method further includes setting a fueling set point at an engine restart after the fuel cut-off event based on feedback from the plurality of exhaust sensors. In a fourth example of the method, optionally including one or more or each of the first through third examples, the method further includes setting a fueling set point at an engine restart after the fuel cut-off event based on feedback from only sensors of the plurality of exhaust sensors matching feedback from the primary exhaust gas sensor.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
adjusting a fueling set point following a fuel cut-off event in response to feedback of a most downstream exhaust gas sensor of a plurality of exhaust gas sensors.

2. The method of claim 1, wherein each of the plurality of exhaust gas sensors is arranged downstream of an aftertreatment device.

3. The method of claim 1, wherein each of the plurality of exhaust gas sensors is a heated exhaust gas oxygen (HEGO) sensor.

4. The method of claim 1, further comprising a universal exhaust gas oxygen (UEGO) sensor upstream of each of the plurality of exhaust gas sensors.

5. The method of claim 1, wherein adjusting the fueling set point comprises adjusting the fueling set point to more rich or more lean based on a state of an aftertreatment device corresponding to the most downstream exhaust gas sensor.

6. The method of claim 1, further comprising returning the fueling set point to a baseline fueling set point in response to the most downstream exhaust gas sensor matching an upstream sensor following the fuel cut-off event.

7. The method of claim 6, wherein returning the fueling set point to the baseline fueling set point comprises incrementally adjusting the fueling set point to match the baseline fueling set point.

8. A system, comprising:
an exhaust system comprising a primary exhaust gas sensor upstream of a plurality of aftertreatment devices;
a plurality of exhaust gas sensors arranged in the exhaust system, and wherein at least one of the plurality of exhaust gas sensors is arranged downstream of at least one of the plurality of aftertreatment devices; and
a controller comprising instructions stored on non-transitory memory thereof that when executed enable the controller to:
initiate a fuel cut-off event;
sense a state of each of the plurality of aftertreatment devices; and
adjust a fueling set point following the fuel cut-off event in response to the state of at least one of the plurality of aftertreatment devices.

9. The system of claim 8, wherein the state of each of the plurality of aftertreatment devices is based on feedback of a sensor of the plurality of exhaust gas sensors directly downstream of a corresponding aftertreatment device.

10. The system of claim 8, wherein the state of each of the plurality of aftertreatment devices indicates if a fueling set point rich or lean of a baseline set point is requested.

11. The system of claim 10, wherein the instructions further cause the controller to adjust the fueling set point based on the state of each of the plurality of aftertreatment devices.

12. The system of claim 8, wherein the fueling set point is further adjusted based on a duration of the fuel cut-off event.

13. The system of claim 8, wherein the fueling set point is incrementally returned to a baseline fueling set point in response to an output of a most downstream of the plurality of exhaust gas sensors matching an output of the primary exhaust gas sensor.

14. The system of claim 8, wherein the fueling set point is adjusted at an engine restart following the fuel cut-off event.

15. The system of claim 8, wherein the fueling set point is incrementally returned to a baseline fueling set point in response to a mass air flow accumulation being greater than or equal to a threshold mass flow accumulation.

16. A method comprising:
operating an engine after a fuel cut-off event;
monitoring a mass flow accumulation via an exhaust sensor positioned downstream of an aftertreatment device; and
adjusting a fueling set point of the engine incrementally toward a baseline fueling set point based on the mass flow accumulation.

17. The method of claim 16, further comprising monitoring the mass flow accumulation prior to the fuel cut-off event and comparing a response of the exhaust sensor to a primary exhaust gas sensor arranged upstream of the aftertreatment device.

18. The method of claim 16, further comprising comparing feedback from a primary exhaust gas sensor arranged upstream of the aftertreatment device to feedback from a plurality of exhaust sensors including the exhaust sensor.

19. The method of claim 18, further comprising setting a fueling set point at an engine restart after the fuel cut-off event based on feedback from the plurality of exhaust sensors.

20. The method of claim 18, further comprising setting a fueling set point at an engine restart after the fuel cut-off event based on feedback from only sensors of the plurality of exhaust sensors matching feedback from the primary exhaust gas sensor.
